(19) United States
(12) Patent Application Publication
(10) Pub. No.: US 2008/0211224 A1
(43) Pub. Date: Sep. 4, 2008

(54) Method And Device For Protecting A Public Or Private Site By Visual Identification

(76) Inventor: Bernard Thoorens, Thines (BE)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/883,195

(22) PCT Filed: Sep. 30, 2005
(86) PCT No.: PCT/IB05/53228

§ 371 Date: Jul. 27, 2007

(30) Foreign Application Priority Data
Feb. 8, 2005 (BE) PCT/BE05/00018

(51) Int. Cl. B42D 15/00; A45C 13/18; B42D 15/10

(52) U.S. Cl. 283/70; 190/102; 283/80

(57) ABSTRACT

The invention relates to a method for securing a public or private place where luggage is stored by or carried through by its holder. The invention is characterized by the fact that inside this place, the required means of identification of luggage is by affixing a portrait of the holder to the luggage in order to consistently establish a direct and unequivocal visual link between the aforementioned portrait of the aforementioned holder. The public or private place is delimited by appropriate means for announcing the obligation or lack thereof to have the said luggage identification. The invention also relates to a mechanism or device for implementing this method.

### TECHNICAL FIELD

The invention relates to a method for securing a public or private place where luggage is stored by or carried through by its holder.

### BACKGROUND TO THE INVENTION

In recent times, securing public places or areas, as well as private ones frequented by individuals carrying or transporting different types of luggage is of utmost importance. In fact, embezzlement or other offences caused by luggage left in high-traffic areas are occurring more and more, posing a major security problem. Luggage inadvertently left behind in public places presents various problems for its holder as well for as the relevant authorities and the security forces.

Many systems have already been proposed. In most cases, these have disadvantages of their own, are too complex to be implemented or have become dangerous.

One example of this is the traditional label, attached to luggage with string, on which the name and address of the luggage holder can be found. This can be dangerous if the information on the tag, which should remain confidential, is copied and used for dishonest purposes.

Under other circumstances, the weaknesses or deficiencies of this system are revealed when one must prove ownership of one's own luggage, particularly when the coordinates of the holder, usually on the luggage, are in a language and handwriting which are incomprehensible to a local agent in another part of the world. This need for proof arises when, for example, identity papers or baggage tags are stolen and there is, as such, no way of verifying identity.

The most recent solutions have also had their limitations. U.S. Pat. No. 6,662,078 proposes a system and a method to ensure the traceability of all objects using a removable identification tag on a piece of luggage, for example that of a passenger on a commercial flight. The tag has identification information: the luggage holder's photograph is created with the tag and appears on the tag itself. All information is recorded on a database and the movement of the luggage and the passenger through different checkpoints is also recorded while the passenger himself is assured that he can have access to this database in the event of difficulty in retrieving his luggage.

Similarly, U.S. Pat. No. 5,920,053 describes a method for identifying a piece of luggage through its holder or passenger. A photograph of this passenger is stored on a computer and the photo and an identifying barcode are printed on the boarding card, the baggage monitoring printout and the baggage tag attached to the handle with a string.

Before the luggage is loaded, its identifying barcode is electronically scanned and compared electronically with the barcode registered for the passenger as well with the bar code on the boarding pass, which was also scanned. The traveller and his photo are compared on a monitor at boarding time and at baggage claim. However, this system is of limited application as it does not allow the securing of an entire zone or area, but only the establishment of checkpoints at specific places, thereby causing more logistical complications. Moreover, perhaps because of its complicated implementation, this method is only proposed for use at a specific point of baggage claim. It thus ensures real security only at this point, and not throughout the area where baggage is being moved or stored. In addition, it violates a passenger's privacy as personal and confidential information is displayed on the luggage along with the picture of the passenger.

Further, US patent application 2004/0098276 discloses a method for checking passengers' and luggage security which involved taking a digital photograph of the passenger, a boarding pass, a baggage tag, a baggage printout. The passenger's photograph and information regarding his identity are stored electronically in the computer's memory.

At the time the baggage is loaded, the information on the baggage tag is scanned and stored, the boarding pass is verified through electronic scanning of the identifying information, and the passenger's photograph compared with his appearance. The passenger is accepted only if this appearance corresponds with that in the photo. Claiming one's baggage is carried out using verification methods identical to those just described. The baggage printout is verified by scanning the passenger's identifying information and comparing the photograph on the baggage tag with the passenger's actual appearance. This passenger is accepted only if he matches the picture. The collection of the luggage is done by using the same identification verification method i.e. by scanning the identification information of the passenger and comparing the picture on the luggage tag/label with the passenger.

As such, the totality of these operations happens at specific points, only allowing for the securing of these points, and not an entire public or private space. Moreover, certain equipment, at the very least a digital camera, must be used at the checkpoint in question. In any case, the high incidence of lost luggage each year has revealed the deficiencies of using luggage tags.

### DESCRIPTION

The purpose of the present invention is to propose a method which makes it possible to mitigate the disadvantages mentioned above, in other words to reinforce, in a simple and inexpensive manner, the security of an entire area, while maintaining the confidentiality of luggage holders' personal information and avoiding data storage and taking photographs, thus respecting anonymity and private life.

To achieve this objective, this invention's method is to identify each piece of luggage, preferably at home, using pockets securely attached to the luggage at places recommended by the instructions sewn into the above-mentioned pockets. Alternatively, the instructions could be provided through other information, publication or illustrative methods in the case of existing luggage, or in the section which is placed at the appropriate location when the luggage is manufactured. A recent photo of the person to whom the luggage belongs is then affixed at the relevant place.

One may only gain access to a secured area by providing luggage identification in the form of a portrait of the holder attached to the luggage to facilitate in a consistent manner a direct and indisputable visual link between the portrait and the luggage holder. By “luggage” or “baggage”, we understand in the context of this description as well as in the claims, all objects capable of being transported or conveyed by the holder himself or by an intermediary within his/her immediate vicinity in such a manner that a direct visual link can be consistently established between the portrait attached to the luggage, and its holder.

As non-exhaustive examples, “luggage” or “baggage” in the context of the invention includes suitcases, briefcases, satchels, handbags, packages, professional or sporting articles, clothing and the like. In the same manner, by “portrait” is meant in the context of this invention, a faithful reproduction of the face of the owner, such as a drawing, or, preferably, a photograph. Preferably, this photograph is the identity photo type reflecting only the face of the owner.

Advantageously, this photograph is a passport-type photograph i.e. reproducing only the face of the holder. This portrait is fixed on the luggage in question in a conspicuous manner place to ensure that it can be easily located and facilitate situations which call for immediate comparisons - for example, in instances where lost luggage is being checked, such luggage is often not recorded. However, a person who has never seen the luggage holder/owner and who speaks a different language may at this stage easily identify the holder of the lost luggage and alert him/her of their mistake. Depending on the nature and amount of the luggage in question, the use of more than one portrait on the luggage may be necessary. Public or private places which may be secured using the invention include, for example, in a non-limited way, stations, halls, airports, public transport, shopping malls, supermarkets, cinemas, club houses and discotheques.

Another feature of the invention is that the perimeters of these places to be secured can be indicated by appropriate means including acronyms, logos or pictograms announcing the obligation or the lack thereof to use the invention's method of luggage identification, that is to say, by affixing a portrait of its holder to it. However, one could define, regulate and inform users through other means that one must attach an identifier to enter and move freely around in these places.

Another characteristic of the invention is that once a piece of luggage becomes separated from its holder in the secured location, be it forgotten, lost or abandoned, an image is sent (of the side of the luggage with the portrait visibly attached to the luggage) to a computer system which resends it to monitors located inside and or outside the secured location or at another location equally secured by the invention, in order to allow the establishment of compatibility between the holder and the portrait on the screen.

In this description, as in the claims, we understand by “image” the image of the luggage and the portrait visibly affixed and if necessary a close-up of the portrait to allow for a better viewing for the final stage, this definition and modality being summed up in the term “image”. The transmission/broadcasting system could, for example, show the “image”: the side of the luggage on which the portrait is directly affixed or in the pocket or in any other way and then show an enlarged version of the portrait on the screen or on the full screen as determined by the operators.

Thus for the luggage abandoned or lost by its holder in the secured area, the image can be carried out by photography This photograph can be taken, for example, with a digital camera, a cellular telephone, an electronic message minder (or a PDA personal digital assistant) a digital video camera, or any other video, photography or camera equipment that can take ‘instant’ shots This image will be transmitted to a central or intermediate computer by a suitable means, such as by an internal network to the secured location or an external one such as the Interne, satellite, fax, or a data-processing treatment unit.

Following this, the image can be retransmitted to display screens located inside or outside of the secured location or to a different secured location such as the information screens in waiting rooms, police monitoring screens, screens in boarding areas, in baggage handling areas, lost and found areas or on means of transportation such as trains or undergrounds/subways, cellular phones and laptop displays, or, generally, to any other screen that can attract the attention of the holder or owner of abandoned or lost luggage, or the attention of a third party, members of the public located in crowded areas or trained or experienced baggage handlers.

This retransmission is best done by one of the means selected for transmitting it to the data-processing treatment unit. If necessary, before transmitting it to the display screens, the image sent to the data-processing treatment unit, can be used for a comparative search with the portraits of suspects or wanted persons in, for example, a police photo file. For instance, this search can be carried out though a central computer and in conjunction with other databases. In the case where the image matches an existing photo of an individual being sought, the re-transmission can be sent uniquely to mobile machines used by agents on patrol inside or at the exit of the secured location.

In cases where there is no match between the image and the portrait of the individual being sought, the announcement can be made on different screens. The images can then be recorded in a database in each secured location, as it has no inappropriate information affecting the individual's private life.

Another advantage of this invention is that it allows a hand luggage holder to be identified by his portrait, where other methods cannot serve as real identification. This can be done without other destination information. He can go to the lost and found office for information on luggage found, for which the images are stored by date and time. Moreover, this central unit can, if necessary allow storage, division and sharing of image files by protected network, satellite or other methods. It can be situated outside the location to be secured while a second computer unit could store internal data as necessary.

Searching for mislaid or lost luggage can be facilitated by installing interactive screens or search systems so that the holder can see the images, thereby accelerating the various steps in the search, lessening waiting periods, annoyance and endless attempts to explain. He could also search the data upon arrival at his destination or at some point in the future and ask the employee how to retrieve or follow-up the luggage, as the employee can know from the image that the requester is the holder.

In the same manner, when this luggage is mislaid through no fault of its holder, for example through a technical barcode-reading error or sending it to a wrong destination, the re-broadcast of the image can be made from the secured location where the lost baggage is located, towards the secured location indicated as the initial destination on the strip attached to the baggage, and in particular in the lost luggage section. As in the previous case, the recording of the data will be sent to the baggage section to inform the holder who has arrived at hi/her destination that his luggage has been found and assist him/her in determining how it can be retrieved.

The method according to this invention as described is based particularly on the placement of a portrait of the baggage holder on the baggage and may be implemented by any appropriate method for securely attaching the portrait to the luggage without the possibility of it being pulled off and also by any method which may reduce the probability of another portrait being attached onto this portrait, such as a portrait other than that of the holder.

For example, such a method could involve printing the portrait directly onto the luggage, through the use of a metal, leather or synthetic material plate, on which the portrait is printed or engraved or through a pocket into which the portrait can be inserted. These plates or pouches are merged with the luggage by an appropriate method for stable attachment, and according to the material used, by sticking, screwing, sewing and any other methods.

Another aspect of the invention is related to a luggage identification mechanism for the implementation of the invention method, a mechanism formed by a pocket capable of holding a portrait of the luggage holder comprising
a) a transparent top sheet with an opening, the top side of this sheet having been treated to prevent the sticking of any unwanted items to it;
b) a base plate, or coated with a transfer glue which can be stuck to luggage and protected by a removable sheet, or at least sporting a buckle into which a strap which is part of the luggage can be slotted, or a base plate with a strap which can be attached inside the luggage.
c) A system for concealing the portrait comprising a middle plate between the top sheet and the base plate, the portrait being placed between the top sheet and the middle plate, in which case it is visible, or placed between the base plate and the middle plate, in which case it is concealed; that is to say a rotating or turning flap, either on the luggage or on the side of the base plate by one of its sides and positioned on top of the top sheet. This flap when closed would cover the top sheet and mask the portrait, and when open, would display the top sheet, revealing the portrait inside.

The transparent, UV-resistant top sheet is usually made using synthetic materials, preferably plastic such as polyvinyl chloride (PVC), polypropylene or similar materials. Moreover, its thickness will be sufficient to resist shocks, rubbing, scratching or tears and its exterior will be treated to prevent the sticking off all unwanted materials. For example, the treatment could be done by putting a silicone coating which prevents sticking or at least reduces the probability of other things sticking to it, particularly a portrait other than the one in the pocket.

As an advantage, this top sheet has a slit/notch which is wide enough for the insertion or removal of the portrait, which is usually a portrait of the holder, as well as the middle plate or concealing plate. This slit or notch will generally be at the edge of this top sheet but outside the perimeter zone reserved for the attachment of this to the base plate.

To ensure that the pocket is tight/secure and water proof, an opening/ closing system for this slit is set up at the top sheet which can include all appropriate systems, for example a sliding or clipping slider or lock made of synthetic material. Also, a part of the sheet's perimeter, usually a part directly facing the slit can be cut into a prehensile tongue to ease the opening of the pouch. This tongue could also be made on the top sheet or on the edge of the opening/ closing system.

The base plate is generally the same size as the top sheet and can be attached to it by attaching the edges by sticking, thermo-fusion, welding, particularly laser welding, laminating or other methods, creating thereby a small pocket/pouch whose size will be determined by the size of the portrait to be inserted. However, some space will be left to allow the free movement of the portrait, as well as of the middle plate through the width of the slit or notch. In addition, this base plate will be coated with glue at the time of its manufacture. The coating will be covered by a sheet which can be removed/discarded when the mechanism is affixed to the luggage.

Another way of doing it, among others, is to make a transfer sticker which will be applied when put onto the luggage. In addition, the base plate which will be made with a flexible, UV-resistant material which could be similar to the type used for the top sheet or that used for the luggage, leather, fabric, or synthetic plastic material, in order to be suitable for application by glue transfer under any circumstances, even if the luggage surface is not hard. In this manner, it will be possible to avoid eventual tearing off of the plate, be it accidental or deliberate, during baggage handling.

Also, this base plate is usually completely covered by a protective glue film, preferably with silicone paper. A diagram outlining the best places to put the device is located at or affixed to the back of this sheet.

With this particular method, several pockets onto which the base plate has been stuck can be on a single protective sheet. These can be separated by cutting the film.

Another method is to individually roll up the pockets, pulled together by the protective film, up, as the film has been pre-cut between each pocket. The back of the protective film can also carry the instructions of the best places to put the device.

The middle plate or the concealing plate is made of thick paper, cardboard or a synthetic polymer such as PVC. It is ideally made of a firmer material than that of the base plate. In addition the edges of this middle plate will be preferably beveled or rounded to ensure easy insertion and removal and to avoid the deterioration of the small pocket. Moreover, this plate will be narrower than the opening of the slit/notch and shorter than the length separating the slit/notch from the bottom of the pocket.

Alternatively, the concealing middle plate can also include two or more shutters/flaps which can be discretely closed hence, not making their presence noticeable. To their advantage, these flaps/shutters can be used as support with information or to support information which can be hidden by folding the flaps/shutters in question. According to another method, the concealing plate can take the form of a rotating or swiveling flap stuck to the front of a frame of which the bottom is merged with the base plate.

Moreover, this flap/shutter comprises a portion of an opening/ closing device which works with a portion compatible with the level of the framework for a closed position and a part on the luggage compatible with an open position on the flap. In addition, the flap in question can be rotated along its edges to ensure its opening or closing. By another method, the flap can pivot/swivel around a means of securing/melding the framework to the base plate, for example a rivet.

In such a configuration, the top sheet and the base plate appreciably and respectively comprise the internal and external dimensions of this frame. Alternatively, this rotating flap can be linked to a flap or tongue which is affixed to an interior or exterior surface of the luggage.

In the case of an existing flap on the luggage the small pocket, is fixed under this flap without the middle plate. The flap when lifted reveals the portrait attached to the luggage or to the normally concealed side of the flap, which becomes visible when totally lifted and remains hidden in its normal position. It would therefore be advisable to have a mechanism to keep the flap in an open position. This would be done by adding some Velcro in a specific position; a pressure/snap button or by adding a device at the manufacturing stage.

Installing a small pocket on the luggage from the manufacturing stage would be preferable, as would putting on the pocket in a way which preserves the aesthetic appearance of the luggage. In this case, another discreet process which uses a flap and normally ensures the closure of the baggage is to affix the base plate to the edge of the flap (where the luggage and the flap meet) using a method which allows for rotation, such as an axis, eyelet or pivot. This would allow the flap to be rotated discreetly revealing the pocket and the photo or vice versa.

Another adaptation of luggage without a flap will entail the steps described above. However in the case of a standard zipper lock, it is advisable to include a notch outside the lock from which the base plate can pivot, the centre of rotation being placed near the upper edge of the bag, and the wall serving to conceal.

Another way of carrying out the assembly, separate from the system of closing the luggage, is by an internal pocket or an incision in order to take out the pocket which is mechanically attached to the bag, by a suitable means, so that the pocket may be taken out and put on the outer surface of the bag, making the identifier visible.

The portrait to be inserted in the pocket for the invention will usually be a photograph. In this case, it will be a passport sized photograph intended to provide a close-up perspective and which will be placed on a piece of luggage which is easy to move and to make visible, such as hand luggage.

For larger bulkier luggage which requires a greater distance for vision, a larger photograph, such as 55×85 mm, will be able to facilitate its location.

If necessary, the portrait could be affixed, possibly with glue, to one of the sides of the middle plate in order to facilitate it being visible or hidden. By simply reversing the plate inside the small pocket, for example, it can be brought out of the line of vision where a discreet way of using the mechanism of the invention can be utilized. On other occasions, this concealing plate with a hidden portrait will be of invaluable assistance in retrieving property, for example, in the event of a dispute at the time of an attempted robbery.

On the other hand, when the portrait is free, in other words, not stuck onto the middle plate, it can be put between the middle plate and the top sheet when it needs to be seen or alternatively, between the base and middle plates when it is to be hidden.

As such, the small pockets built in this manner can be varied in color and form. They can have geometric or random forms. They can also be made with different materials as wide as the margins of the slot/window; while their size and dimensions will be modified to the format of the portrait as required or desired.

These small pockets will be firmly attached to the baggage, for example through an adhesive covering the bottom side of the base plate, whether the luggage is bulky or not, or by other methods depending on the material(s) of the luggage, namely by sewing, riveting, hooks and eyelets.

This attachment will be done at arranged places on the luggage to facilitate an immediate and irrefutable visualization of the holder's portrait. Towards this end, areas where baggage is likely to be covered by other baggage or by other items such as scarves, head-ties, small bags or other things would be avoided. These could be obscure zones, near to a prehensile system or those which are too far, such as close to the ground or requiring unnecessary handling.

The method according to the invention, for securing public or private places has a number of advantages, particularly in relation to other procedures for similar purposes. These include
1) Installing the identification system at home before arrival at certain areas raising security concerns, such as public transport;
2) Equipping any and all existing baggage without a waiting period and without waiting for it to be installed;
3) Facilitating a security check, before entering a public or private place, which is an effective deterrent to wrongdoers and contrary to most existing procedures;
4) Offering a flexible, scalable, inexpensive method which is easily implemented in all places and for any individual, which allows for an effective implementation from the first phase and simple visual monitoring;
5) Respect for privacy and anonymity while displaying the information;
6) Using an image, such as a photograph for abandoned, lost or suspicious baggage in a secured location, from the portrait attached though the invention, without handling the baggage in question;
7) Consistently and during checks in the secured location, authenticating, by simple visualization, the holder and the baggage he owns or which he is transporting by accompanying them;
8) Improving and complementing existing systems;
9) Avoiding deliberate or accidental tearing off and removal of the device because of its attachment to the luggage itself, which reduces the risk of forgery;
10) Establishing the trust of the traveller who is not concerned about identifying and locating luggage amongst other similar luggage;
11) Removes the need to attach personal details (name, address, telephone numbers) of the baggage holder and avoids sending this information to the home of the holder and thus revealing his absence;
12) Ensures that anonymity and private life are respected as private information is not posted on or in connection with the luggage.
13) Outside secured locations with compulsory security checks, persons have the option and opportunity of using the mechanism in question in a discreet way, by concealing the portrait;
14) Allows non-registered baggage to be located;
15) Allows the portrait to be seen at all times through affixing it on both sides of a bulky piece of luggage;
16) The portrait of the holder provides a quick, effective, irrefutable and universal identifying method, irrespective of the place where the check is effected, and of all languages and handwriting;
17) A quick response time in luggage theft cases as the wrongdoer cannot show his portrait on the luggage and putting a false sticker over the upper side of the transparent top sheet can be easily spotted and removed.
18) Dissuades a wanted individual from putting his portrait on luggage, sometimes at several places, because he is trying to be discreet;
19) Reduces the quantity of anonymous or abandoned luggage in public areas such as airports, stations and other crowded or supervised areas, given the speed at which the holder of the baggage in question can retrieve it;
20) Allows for the portrait to be broadcast to different monitors at buildings or on transport networks, so that, at time of the security check, several different portraits on different luggage can be examined consecutively and repeatedly, allowing time to better reconcile a mental portrait and that of the luggage holder;
21) Ensures follow-up of lost or abandoned luggage after the holder identifies himself;
22) Allows information to be transferred to various security agents or others operating from the secured location and in surrounding areas particularly, in the event of wrong doing,
23) Discourages an individual to walk with luggage publicly displaying a portrait other than his, or behavior which camouflages a portrait which is not of him;
24) Encourages passive and involuntary participation of the public, who are likely to notice differences between the portrait on luggage and an individual other than the luggage holder who may wish to take or steal it;
25) Discourages the application of a portrait on the transparent sheet of the invention's mechanism as a superimposed portrait is immediately recognizable and easily removed;
26) Dissuades a baggage thief, who would have to obtain a large number of sometimes different portraits and who would be under increased suspicion for this reason in the event of an arrest;
27) In case of theft, the robber can be foiled immediately without dispute, producing identification documents or even by providing interpreters.
28) The holder of a stolen piece of luggage is not obligated to search for his own identification papers, which at a time of emotional stress, could take a long time, enough for a suspect to escape;
29) At the time of loading, allows image of the luggage and its portrait to be transmitted on screens in appropriate modes of transport, such as a plane or boat and reassures the traveller of the retrieval of his luggage as soon as possible;
30) Reduces the number of destroyed luggage which has been deliberately disguised or unclaimed by its holder;
31) Allows the handler at the time of a transfer to ensure that the baggage is being given to the person whose portrait is affixed thereon.
32) Allows for identification of luggage which is deliberately identical, such as that belonging to members of sporting clubs, teams, professional staff and various organisations;
33) Allows the baggage holder to easily find it after having been handed over several times to different storing and distribution places;
34) The ability to render one's baggage discreet outside of public places by using the middle sheet, placing it between the top sheet and the portrait where, when the portrait stuck to this middle sheet is visible through the top sheet, tuning this middle sheet to hide the portrait;
35) Increases the difficulty level for ill-intentioned persons to steal a piece of luggage bearing a portrait other than theirs, in the presence of other persons;
36) Allows the holder of a lost/forgotten piece of luggage to be recognised and to alert the holder to this when he has moved away from the luggage;
37) Facilitates luggage identification methods for luggage found at or sent to wrong destinations without having to open then and while avoiding suspicions of theft;
38) Reduces the cases of persons rummaging through your bag, under the pretext of being confused as to whether the bag was theirs;
39) Reduces the storage and handling of lost items;
40) Avoids having locks on luggage forced opened by the wrong person or searching for signs of ownership, and thus lowers possibility of theft and loss of privacy.

### BRIEF DESCRIPTION OF DIAGRAMS

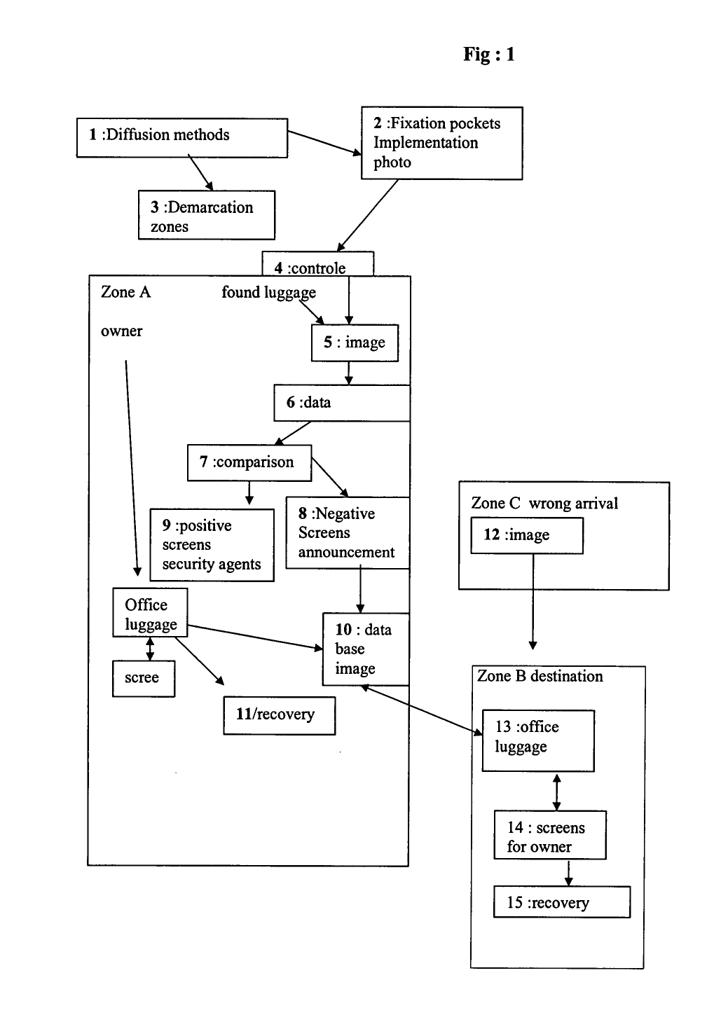

FIG. 1: represents a block diagram of the security method of the invention.

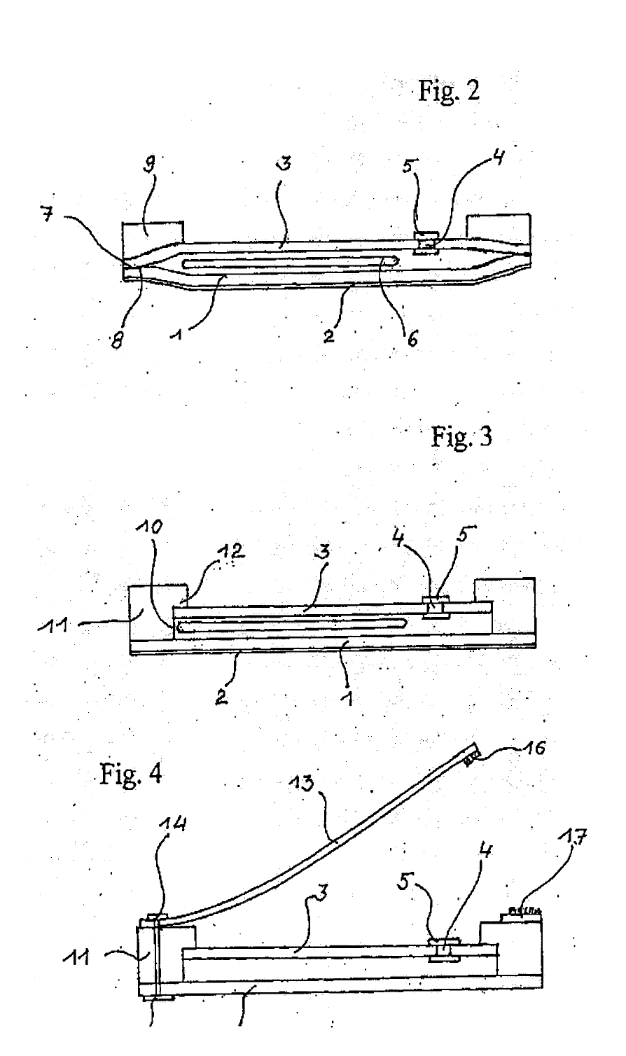

FIG. 2 is a representation of a cross-section an identification mechanism according to the invention.

FIG. 3 represents a cross-section of another way of implementing the mechanism in FIG. 2.

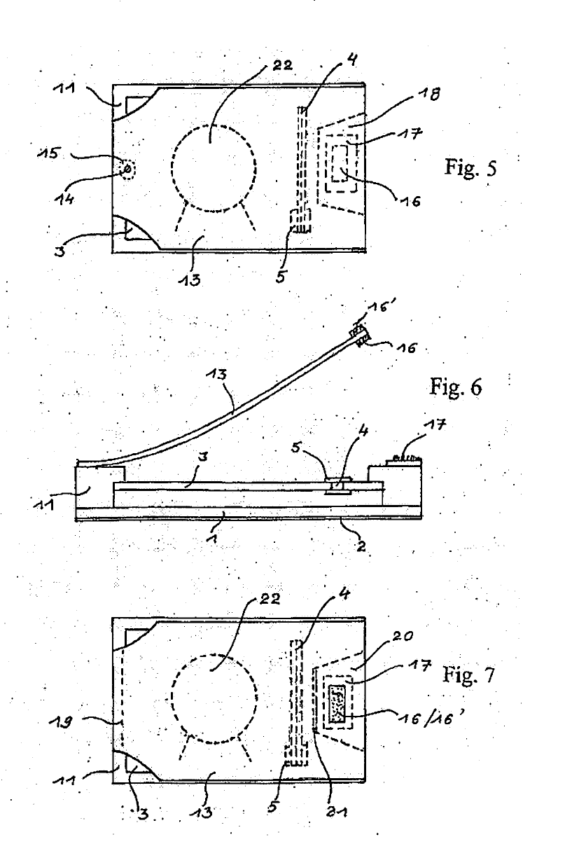

FIGS. 4 and 5 are cross-sectional and flat representations, respectively, of another way of implementing the mechanism in FIG. 3.

FIGS. 6 and 7 are cross-sectional and flat representations, respectively, of another way of implementing the mechanism in FIGS. 4 and 5.

### DETAILED DESCRIPTION OF DIAGRAMS

The invention will be better understood and its other objectives, characteristics and advantages will become clearer during the explanatory description which will follow. This will be done with the aid of the design diagrams which are given only as examples to illustrate possible implementation methods of the invention, and are not exhaustive. As such, the invention, including the method and the mechanism for its implementation, allows:

FIG. 1: Step 1: releasing the information defining: 1)public or private places for which visual identifiers are used for security purposes; 2) methods of installing/inserting/placing photographs and pockets; 3) elements facilitating the delimitation or definition of areas and the visual modes of delimitation.

Step 2: Securing and visibly affixing to each piece of luggage accompanying its holder at least a portrait of him and at suitable places at a distance from the handles and areas which can be covered by luggage, head-ties, scarves and sachets. These instructions can, for example, be put at the back of the adhesive and protective transfer sheets, or on the envelopes with the small pockets and data for all other means of informing of the steps to follow in order to ensure that all luggage has been equipped with their identifiers, before entering secured areas.

Step 3: Delimit a zone, A, or a space in which baggage either remains or is transported along with its holder, for example an airport, in order to secure the area so that every piece of baggage entering or having entered may be identified.

The delimitation of the perimeter is carried out by affixing to the entrances instructions that can be easily understood by any individual, no matter what language he speaks, which inform of the need to constantly display one's portrait on the baggage in the area. The instructions should ideally be presented in a pictorial form, for example, a logo or pictogram. Similarly, the instructions showing the end of the security zone are visibly placed at the exits of the secured area. However, where these signs are not present for various reasons a regulation can be implemented to apply the identification use requirement.

Additionally, to ensure an immediate and systematic visual check with regard to the instructions previously summarised, it is preferred to install check points at the entrances.

Step 4 Such a check at the entry of the secured location serves as a disincentive to ill-intentioned persons and ensures that each piece of luggage is properly identified. Inside this secured location A, the portrait affixed to the luggage should be kept clearly visible in such a way that a checkpoint officer, an employee or a third person could at any time, even by chance, make a direct visual connection between the portrait on the baggage and the holder of the baggage.

In the event that a piece of luggage is found to be separated from its holder in the location, be it lost, forgotten or abandoned, a check point officer may, in Step 5, create an image of the front of this baggage where the portrait is located. Usually this will be a photograph, for example digital.

At Step 6 the photograph is transmitted to a data-processing unit such as by a central computer or intermediate computer or a display screen from the main console.

At step 7, where required, a comparison between the transmitted image of the portrait and the portraits of wanted individuals or suspects in both manual and electronic files, can be carried out, for example by customs or police personnel.

Step 8: In the event that there is no match, the image combined with an enlargement of the portrait can be retransmitted by the data processing unit via the airport's internal network and/ or by the Internet to different monitors which can be accessed by the public or by staff at the airport, primarily through screens located at departure lounges, check-in areas, boarding locations, in transit lounges, waiting rooms, restaurants, etc. This wide broadcasting of the image will increase the probability of attracting the attention of the holder or that of a third person so that the holder can recover his luggage.

Step 9: In the event that the image matches the photo or information of a wanted person, this image can be modified to accentuate the face of the individual and transmitted to and displayed on the screens of machines owned by individual travellers, ensuring the security inside and outside the secured location, for example on cellular phones.

Step 10: Inages captured shall be kept in an image database of found luggage. This base will be accessible to/from other secured locations through the previously described communication methods.

Step 11: Recovering lost luggage at the place of departure if there is enough time at the lost and found section, if not, the information will be available in the image database of zone A, which is accessible upon arrival at zone B.

In addition, in the event that, after being incorrectly sent to a secured location from another one, a piece of luggage is found in a secured but incorrect location C, an employee can create an image of the luggage concerned, such as a digital photograph, which also reveals the portrait of its holder, and transmit it to the lost and found section in zone B using the information attached to the bag which cite zone B as the correct destination.

The image may be retransmitted in stage 13, for example through satellite transfer, on the zone B screen, where the baggage holder would be. This would preferably be on screens located in the welcome area and/or baggage handling, indicating to the holder that his lost luggage is in that zone. In this manner, in step 14, the baggage holder can go to the lost and found office to consult the image file and identify the image matching his baggage. The agent can indisputably authenticate the holder and his image and arrange for the recovery of the luggage at the most suitable place. This can be received at home or there where he has a real and urgent need, without the risk of finding an open or forced piece of luggage as might be the case with other methods.

The invention's method, as described, can be implemented through a baggage identification mechanism. This mechanism is a type of pocket as represented in FIG. 2. This identification mechanism comprises a base plate (1), generally rectangular and made, for example, of polypropylene, having on its bottom side coated with a transfer adhesive designed to adhere to all materials generally used for manufacturing luggage and protected by a sheet of removable silicone paper (2). This base sheet has above it a top sheet (3), which is transparent, generally rectangular and ideally made out of polyvinyl chloride (PCV), with a lateral incision (4) protected by a sliding lock or zipper (5) which can ensure the insertion and removal of a portrait. In order to avoid all sticking of any foreign object/matter on the upper side of transparent sheet (3), the surface will be treated in an appropriate manner such as with a silicone coating.

Furthermore, this mechanism is equipped with a middle plate (6), generally rectangular in shape and placed in between the top sheet and the base plate. This middle plate is ideally made out of cardboard, leather or a synthetic material such as polyethylene and has beveled or rounded edges. The top sheet and the base plate, which are the same size, are attached by the sticking or welding of their respective edges (7 and 8) in order to create a pocket capable of holding both the middle plate (6) and the portrait, both smaller in size than the top sheet and the base plate. The portrait may be smaller than the middle plate.

The mechanism so assembled may be further stiffened and strengthened by a frame (9), for example in leather, supported by the edge of top sheet (3) and stuck or welded to it.

Using another implementation method for the invention's mechanism, represented in FIG. 3, the top sheet 3 is inserted into the inside edges (10) of a frame (11) of which the upper part extends into an overlap running along the inside periphery of the frame and partially covers top sheet (3). Additionally, the bottom of the frame is on the edge of the base plate (1), whose size is therefore greater than those of the top sheet 3. This combination may be brought together using methods such as sticking or welding, base plate (1) at the bottom of the frame (11), the transparent sheet (3), either on the bottom of overlap 12, or at the top of base plate 1 (not shown), or at both (not shown).

Another way of implementing the pocket at FIG. 3, shown at FIGS. 4 and 5, uses a portrait concealment system composed of a flap (13), opaque and rotating. This flap, made of a material such as leather or a flexible synthetic material, is affixed using a rivet (14) and an eyelet (15) to the ensemble formed by frame (11) and the base plate (1).

The opening and closing of this flap can be obtained by strips of self-adhesive strip of the VELCRO© variety. Such a pocket could be affixed to the baggage using rivets and eyelets put in each of the comers of the pocket. Moreover, in another implementation method for the mechanism in FIGS. 4 and 5, represented in FIGS. 6 and 7, flap 13 is welded or sewn if the materials allow it, so that the flap can rotate in 19. The opening and closing ability of this flap can be obtained through pieces of self-adhesive strip 16/16′ and 17.

FIG. 7 also shows a prehensile tongue or strip (20) on the top sheet 3 right next to the slit (4) and welded to this sheet in (21). This strip/tongue (20) allows the slit to be opened when the pocket is affixed to the baggage.

In light of the foregoing, one understands that affixing the invention's mechanism to the luggage by one or the other methods described in FIGS. 1, 2, 3, 6 and 7 is done by sticking it by the base plate which is covered in an adhesive transfer (glue), after removing the protective silicone film (2).

The place(s) on the baggage for affixing the mechanism will be selected to make the attached portraits particularly visible from outside, which will simultaneously allow for both identification and an almost automatic comparison between the(se) portrait(s) and the holder of the baggage in question.

However, by using the method of the invention, baggage holders with the above mechanism may move discreetly outside of the secured location, that is, with the portraits on the baggage concealed.

For this purpose when the mechanism shown in FIGS. 2 and 3 is employed, the portrait inside the pocket, initially placed in a visible position between top sheet (3) and middle plate (6), is removed from this pocket by opening (4) and reintroduced by the same entrance, between this middle plate and the base plate. However, when this portrait is stuck to the middle plate, this may be removed from the pocket and reinserted after tuning it in such a way as to support the portrait against the base plate.

On the other hand, the small pocket in FIGS. 4 and 5, whose flap (13) is initially in a closed position can be adjusted by using strip (16 and 17). A visible position requires the strip to be opened and turned 180 degrees around rivet (14), thereby moving transparent sheet (3) and revealing portrait (22). This flap can be kept open if necessary by connecting strip (16) and a strip (not shown) affixed to the baggage. This strip would be the same as strip (17).

In a similar manner, the small pocket in FIGS. 6 and 7 whose flap (13) is initially in a closed position with the help of strips 16 and 17. For the portrait inside to be visible, flap (13) must be opened and rotated 180 degrees around welded seam 19 in order to detach top sheet (3) and reveal the portrait (22). This flap can be kept in an open position if necessary by connecting strip (16) and a strip (not shown) affixed to the baggage. This strip would be the same as strip (17).

Alternatively, these mechanisms in FIGS. 4 to 7 need to operate in a manner opposite to the abovementioned, to have the portrait remain visible and where discreet use of the portrait is a consideration.

1-19. (canceled)

20. A method of securing, by visual indicia, a public or private place in which baggage is stored or transported by its holders, the method comprising:
affixing a holder's portrait to the holder's baggage to establish a visual link between the portrait and the holder;
conditioning access to the public or private place on the presence of the holder's portrait affixed to the holder's baggage to confirm a visual match between the holder and the portrait; and
responding to separation of the holder's baggage from the holder by:
obtaining an image of the holder's baggage with the holder's portrait affixed thereto; and
transmitting the image to at least one monitor in the public or private place to indicate the separation of the holder's baggage from the holder.

21. The method of claim 20, further comprising notifying holders of baggage of an obligation to use baggage identification in specified locations of the public or private place.

22. The method of claim 21, wherein notifying holders of baggage of the obligation to use baggage identification in specified locations of the public or private place is accomplished by posting visual notifications at a perimeter of the specific locations to be secured.

23. The method of claim 20, wherein affixing the holder's portrait to the holder's baggage is performed prior to arrival of the holder at the public or private place.

24. The method of claim 20, wherein affixing the holder's portrait to the holder's baggage comprises affixing the holder's portrait to the holder's baggage at a plurality of locations on the holder's baggage.

25. The method of claim 20, wherein the holder's portrait is equipped to prevent foreign objects from sticking to or otherwise damaging the holder's portrait.

26. The method of claim 25, wherein the holder's portrait is equipped with a protective silicone film.

27. The method of claim 20, wherein obtaining an image of the holder's baggage with the holder's portrait affixed thereto is performed by a film-based camera, a digital camera, a cellular phone, an electronic message minder, a digital camcorder, or a Polaroid camera or another apparatus enabling instantaneous photography.

28. The method of claim 20, wherein responding to separation of the holder's baggage from the holder further comprises:
comparing the holder's portrait to a database of wanted persons.

29. The method of claim 20, wherein responding to separation of the holder's baggage from the holder further comprises:
storing the image of the holder's baggage with the holder's portrait affixed thereto in a database that is accessible to a lost and found department and to the holder.

30. The method of claim 29, wherein the image of the holder's baggage with the holder's portrait affixed thereto is searchable via at least one interactive screen in a lost luggage section of the public or private place.

31. The method of claim 29, wherein the database storing the image of the holder's baggage with the holder's portrait affixed thereto is accessible via the Internet.

32. The method of claim 20, further comprising responding to transfer of the holder's baggage by error to a secured location other than that indicated by a destination tag attached to the holder's baggage by transmitting the image of the holder's baggage and the holder's portrait to a lost luggage section of a secured location indicated by the destination tag.

33. The method of claim 20, further comprising responding to a match between the holder's portrait and an existing image of a wanted person by selectively transmitting the image of the holder's baggage with the with the holder's portrait affixed thereto to monitors used by agents of the public or private place.

34. A luggage identification mechanism adapted to carry out the method of claim 20, comprising at least one pocket capable of holding the holder's portrait, including:
a transparent top sheet that is resistant to shock, rubbing, scratching, tearing and ultraviolet rays, bearing a slit, and being resistant to sticking of foreign objects thereon;
a base plate having an adhesive transfer material for sticking onto baggage, protected by a detachable film; and
a portrait concealment system including a middle plate between the top sheet and the base plate, the holder's portrait being receivable either between the top sheet and the middle plate, in which case it is visible, or between the base plate and the middle plate, in which case it is concealed.

35. The luggage identification mechanism of claim 34, wherein the top side of the top sheet includes a silicone film.

36. The luggage identification mechanism of claim 34, wherein the top sheet includes an opening/closing system for the slit that includes a zipper.

37. The luggage identification mechanism of claim 36, wherein the zipper includes a snap system that has a prehensile aspect in the form of a total or central molded edge with an external size on a male of female part located on a top side of the pocket.

38. The luggage identification mechanism of claim 34, wherein an internal space is provided between a wall of the baggage and its locking system, and the pocket or the base plate is affixed by one of its corners to a pivot so that rotation of the pivot reveals the holder's portrait affixed to the place or inserted into the pocket.

39. The luggage identification mechanism of claim 34, wherein the detachable film of the base plate is a silicone sheet.
